(19) United States
(12) Patent Application Publication
(10) Pub. No.: US 2013/0187580 A1
(43) Pub. Date: Jul. 25, 2013

(54) Controller For Back EMF Reducing Motor

(71) Applicants: James F. Murray, III, Oklahoma City, OK (US); Erik J. Brauer, Edmund, OK (US)

(72) Inventors: James F. Murray, III, Oklahoma City, OK (US); Erik J. Brauer, Edmund, OK (US)

(21) Appl. No.: 13/562,214

(22) Filed: Jul. 30, 2012

Related U.S. Application Data
(63) Continuation-in-part of application No. 12/993,941, filed on Dec. 3, 2010, now Pat. No. 8,373,328.
Application No. 12/993,941 is a continuation-in-part of application No. 13/390,437, filed on Feb. 14, 2012.
(60) Provisional application No. 61/058,824, filed on Jun. 4, 2008.
(60) Provisional application No. 61/234,011, filed on Aug. 14, 2009.

(51) Int. Cl. H02P 6/14

(52) U.S. Cl. CPC H02P 6/14
USPC 318/400.3

(57) ABSTRACT

Embodiments of controllers for electric motors, and methods of operation for the same are disclosed. More particularly, the controllers and methods of operation are for motors designed to operate so as to reduce Back EMF.

### CROSS REFERENCE TO RELATED APPLICATIONS

This application is a continuation-in-part of application Ser. No. 12/993,941, which has a 35 U.S.C. §371(c) date of Dec. 3, 2010, and which in turn is a 35 U.S.C. §371 filing of Application No. PCT/US09/46246, filed Jun. 4, 2009, which in turn claims the benefit under 35 U.S.C. §119 to provisional Application No. 61/085,824, filed Jun. 4, 2008, and the entire contents of each are hereby incorporated by reference.

This application is also a continuation-in-part of application Ser. No. 13/390,437, which has a 35 U.S.C. §371(c) date of Feb. 14, 2012, and which in turn is a 35 U.S.C. §371 filing of Application No. PCT/US10/45298, filed Aug. 12, 2010, which in turn claims the benefit under 35 U.S.C. §119 to provisional Application No. 61/234,011, filed Aug. 14, 2009.

This application is also related to the following concurrently-filed applications: application Ser. No. ______, titled “Multi-Pole Switched Reluctance D.C. Motor with Constant Air Gap and Recovery of Inductive Field Energy;” application Ser. No. ______, titled “Three Phase Synchronous Reluctance Motor With Constant Air Gap And Recovery Of Inductive Field Energy;” and Provisional Application No. ______, titled “Multi-pole Electrodynamic Machine With A Constant Air Gap And An Elliptical Swash-plate Rotor To Reduce Back Torque;” each of which are hereby incorporated by reference.

### FIELD OF THE INVENTION

The disclosed inventions relate to the field of controllers for electric motors, and more particularly to controllers for motors designed to operate so as to reduce Back EMF.

The disclosed inventions also relate to the field of direct energy conversion and the production of mechanical torque from the utilization of an electric current, and to the field of electric motors and to utilization of direct current as a “motive force.” The disclosed inventions also relate to the field of power conversion devices which transform electrical power into rotary mechanical power.

Some disclosed embodiments relate to a class of motor having multiple stator and rotor sections, such that each rotor section is associated with a specific stator section, although attached to a single output shaft. The lateral axis of each rotor section may be disposed at an oblique angle with respect to the axis of the common shaft, and angularly displaced in accordance with the number of rotor sections employed, for example: 90 mechanical degrees for two rotors, 120 degrees for three rotors, etc.

Some disclosed embodiments also relate to multiple motors having two or more motor sections, operating in parallel, each of which is comprised of a stator having two or more salient poles, and a rotor geometry devoid of coils or windings of any kind, affixed obliquely to a motor output shaft, and so disposed as to ensure a constant air gap between the rotor body and the salient poles of an associated stator section.

Some embodiments of the invention also relate to multiple motor sections with their associated armatures, mechanically positioned out of phase with one another, but mounted so as to allow the output pinions of each individual motor to impinge upon a common output gear of larger diameter, mounted upon a separate but common output shaft, such that each individual motor's output is combined mechanically, and afforded an amplification of torque.

Some embodiments of the invention also relate to a single motor having a stator section with salient poles, and a rotor geometry devoid of windings, affixed obliquely to a motor output shaft, and disposed as to ensure a constant air gap between the rotor body and the salient poles of the stator section.

### BACKGROUND

Notwithstanding the increased interest in energy conversion over the recent decades, no substantial advances have been made in increasing the conversion efficiency of electric motors. Rather, the art has made incremental advances relating to improved magnetic materials, more powerful permanent magnets, and sophisticated electronic switching devices. Such improvements, at best, relate to very small increases in overall efficiency, usually gained at very considerable expense.

Patents in this area include: U.S. Pat. Nos. 2,917,699; 3,132,269; 3,321,652; 3,956,649; 3,571,639; 3,398,386; 3,760,205; 4,639,626 and 4,659,953. Also in this area are EPO patent no. 0174290 (March 1986); German patent no. 1538242 (October 1969); French patent no. 2386181 (October 1978) and UK patent no. 1263176 (211972).

The basic concept employed in earlier motor art is the interaction between a current carrying conductor(s) and a magnetic field of some kind. This fact is true regardless of motor type. This basic concept appears in DC motors, single phase AC motors, poly phase induction slip motors, which utilize a rotating magnetic field, and in poly phase synchronous motors with externally excited electromagnetic cores, or permanent magnet cores as the case may be.

Other types of designs may be found, for example, in the design of stepper motors, which utilize a magnetic “ratcheting” action upon magnetic material in the armature, in response to applied pulses of current, and various types of reluctance motors in which the rotor moves with respect to a salient pole piece, experiencing a large variation in air gap during its motion. But, these devices typically do not have a constant and continuous air gap of fixed dimension between the rotor and the stator.

The prior art has not produced a multiple phase, multiply segmented stator with individual, obliquely disposed, laminated armatures devoted to each stator section, such that each stator/rotor combination employs a continuous air gap of constant dimension, regardless of the elliptical profile of said armatures, but not employing any current carrying conductors, coils, windings or bars within or upon the armatures, as a means of producing torque upon the output shaft.

Nor can it be said that the prior art has arranged such motors to cooperate in “parallel fashion,” through a reduction gear arrangement so as to provide an amplification of torque while sharing the mechanical load.

A previous example exists which describes an alternator having a single rotor canted at an angle, and makes use of the unique rotor design featured within this disclosure. Said rotor was introduced in the power conversion device entitled “Alternator Having Improved Efficiency,” which was invented by James F. Murray III, filed as application Ser. No. 07/112,025, on Oct. 21, 1987, and later granted U.S. Pat. No. 4,780,632 on Oct. 25, 1988, and is herein incorporated by reference.

There are marked differences between the presently disclosed inventions and the inventions disclosed in the “Alternator Having Improved Efficiency,” patent (“the Alternator Patent”). A few non-limiting examples of which are listed as follows:

1.) Alternator of the Alternator Patent can be operated as a motor only when used in conjunction with the basic motor concepts described herein (i.e., requires field flux and current-carrying conductors).

2.) Alternator of the Alternator Patent does not require salient pole projections in order to operate.

3.) Alternator of the Alternator Patent makes use of an electromagnetic field winding, or a permanent magnet as its source of magnetic flux.

4.) Alternator of the Alternator Patent does not require a shaft position indicator, or a commutator of any kind in order to function.

5.) Alternator of the Alternator Patent does not require a position sensitive, electronically controlled, pulsed power supply, in order to generate electricity.

Other similarities between the Alternator Patent and the presently disclosed inventions include elements possessed by most rotating power converters, such as bearings, shafts, end bells, laminations, mechanical housing, etc.

As evident from the above discussion, electric motors have been in use for well over 100 years, and they exist in several forms. While, the basic concept has not substantially changed, the manner in which the switching of supply current is controlled has evolved. However, existing motors typically experience performance limitations due to the manner in which Back EMF and inductive field energy are treated. The generation of Back EMF in motors of all kinds is chiefly due to two things: the movement of conductors through a magnetic field, called Speed Voltage, and the rate of change of current through a winding, called Transformer Voltage. Conventional wisdom suggests that Speed Voltage Back EMF is totally unavoidable, and in fact, is necessary for the transformation of electrical power into mechanical power in a typical motor. However, one drawback of Speed Related Back EMF is its parasitic nature that serves to degrade the potential supplied to the motor from an outside source (i.e., the source voltage).

The parasitic nature of Back EMF arises from, among other things, the mistaken assumption that Back EMF is required to produce torque. This, in turn, leads to design compromises which must be made in order to implement traditional electrodynamic machine geometries. Consider, for example, a conventional DC Motor consisting of a stator with salient field poles, and a rotor-armature with a self-contained commutator. Application of a DC current to the rotor leads produces a rotary motion of the rotor (i.e., motor action). However, the rotation of the rotor conductors in a magnetic field also induces a voltage in the conductor that opposes the current applied to the rotor leads (i.e., generator action). These facts actually demonstrate an important aspect of conventional machines; if standard design parameters are always followed, then any motor must perform as a generator while it is running, and any generator must perform as a motor while it is in operation. The explanation of this similarity is because both machines are dependent upon the same basic geometry for their functionality, and so, both motor and generator action occur simultaneously in both devices.

The above-described basic geometry of a conventional Speed Voltage based system results in the production of parasitic Back EMF as follows. In a Speed Voltage based system, the magnetic flux must interact with an electrical current-carrying conductor (e.g., rotor windings), thereby producing a mechanical force that generates a torque to turn the motor shaft (i.e., a motor action). The subsequent motion of the conductors through the magnetic flux produces a relatively high Back EMF (i.e., acts in opposition to the torque producing current) due to the motion of the conductors with respect to the magnetic flux (i.e., a generator action). In order to continue normal operation, and establish electrical equilibrium, any motor that produces a Back EMF having a constant average value, must draw down on the line-potential in order to overcome the effects of this parasitic Back EMF voltage. Thus, this process of source potential degradation due to Back EMF requires the input of considerable energy from the source in the form of a voltage in order to maintain normal operation.

Another design factor of conventional Speed Voltage dependent machines is that, typically, as the rotor turns from pole to pole the air gap between the rotor and the stator will vary in width (from a smaller gap when the rotor is “facing” a stator pole, to a larger gap when the rotor is “between” stator poles). This change in the air gap results in a change in the magnetic potential energy within the air gap resulting in the Back EMF component described above. These and other significant issues and inefficiencies persist in traditional DC motor designs.

Before turning to the improvements and advantages of the disclosed inventions, a brief review of some fundamental concepts for electric motor operation is instructive. The basic premise is that the force developed by a current carrying conductor immersed in a magnetic field is described as (equation 1):

F=BlI,

where, F is the force developed, B is the flux density, l is the conductor length, and I is the current. This simple equation suggests that a current-carrying conductor situated in a magnetic field will experience a force that is directly proportional to the applied current, the flux density and the length of the conductor. This principle underlies the operation of the millions of electric motors spinning every day in locations all over the world.

The voltage produced by a conductor moving through a magnetic field can be described using (equation 2):

V=Blv,

where, V is the voltage developed, B is the flux density, l is the conductor length, and v is the tangential velocity of the conductor as it rotates. Accordingly, if a conductor is moved through a magnetic field by an external motive force (e.g., a prime mover), then the voltage produced may give rise to a current in the conductor, and such a device exhibits generator action. Conversely, if a conductor is carrying a current, and thereby moves through a magnetic field under the influence of the current itself, the device exhibits motor action. However, in the act of moving through the field a voltage is produced within the conductor in accordance with equation 2, and acts in such a manner as to diminish the applied current responsible for the conductor's motion, and this produced voltage is typically referred to as a Back EMF.

Examining the actual power present in the system can be accomplished as follows. Mechanical power can be expressed as the product of Force and Velocity. Velocity is therefore missing from the first relationship (equation 1), but it can be included by multiplying both sides of equation 1 by the additional parameter:

Fv=BlIv.

The resulting expression now denotes a form of mechanical power expressed as (equation 3),

Pm=BlIv,

where, Pm denotes mechanical power.

In similar fashion, the voltage expression (equation 2) denotes only potential, not power. Electrical power can be expressed as the product of voltage and current. Current is missing from the second relationship (equation 2), but it can also be included by multiplication to both sides of the equation:

VI=BlvI.

The resulting expression now denotes a form of electrical power as (equation 4),

Pe=BlvI.

Note that BlIv (equation 3) is equal to BlvI (equation 4), and therefore, Pe must be equal to Pm. This analysis is as expected, and holds with current theories that stipulate the applied power is equal to the output power minus the system losses.

Another important factor to consider is the magnetic flux in a DC motor. The flux, Φ, can be expressed as (equation 5):

Φ=LI,

where L is the inductance and I is the current. Taking the derivative of the flux expression with respect to time, t, yields:

dΦ/dt=d(LI)/dt.

Substituting V for dΦ/dt gives (equation 6):

V=LdI/dt+IdL/dt.

The first term in equation 6 is the product of inductance (L) and the rate of change of current (I) with respect to time (t). This is the previously discussed Transformer Voltage Vt. The second term is the product of the current (I) and the rate of change of Inductance (L) with respect to time (t). This is the previously discussed Speed Voltage Vs. Thus the relationships for each Voltage type is:

Transformer Voltage (equation 7), Vt=L dI/dt, and

Speed Voltage (equation 8), Vs=I dL/dt.

Expressing Vt and Vs in terms of the energy can be accomplished as follows. The field energy, Pt, due to the Transformer Voltage may be expressed as follows:

Pt=IVt.

Substituting for Pt and Vt gives:

dE/dt=I dΦ/dt. Simplifying to (equation 9):

dE=IdΦ.

Equation 9 expresses the quantity commonly referred to as the reactive energy. The dissipative energy for the system can, likewise, be expressed as follows. Starting from equation 8, Vs=I dL/dt, and realizing that L=Φ/I, then L=Φ(I⁻¹), and dL/dt=Φ I⁻²dI/dt.

Substituting (Φ I⁻²)dI/dt for dL/dt=gives:

Vs=I(−Φ/I²) dI/dt. Multiplying both sides of the equation by I yields an expression for dissipative power, Ps. But, VsI=dE/dt, therefore, Ps=dE/dt=−Φ dI/dt, and (equation 10):

dE=−ΦdI.

Combining equation 9 and equation 10 the total energy in an air-gap is (equation 11):

E_{T}=IdΦ+ΦdI.

The energy relationship described in equation 11 can be further explained with reference to FIG. 1, which depicts a plot of flux (Φ) versus current (I) of the air gap energy components. As shown, the line 100 represents the total magnetic energy given by (equation 12):

Em=IΦ.

The region 110 above line 100 indicates the (I dΦ) reactive energy region and region 120 below line 100 indicates the (Φ dI) dissipative energy region.

The relevance of this energy relationship can be further explained with reference to FIGS. 2A and 2B which show a cross-sectional representation of a prior art reluctance motor. As shown in FIG. 2A, rotor 210 is in a position between two stator 200 poles yielding the motors largest air gap 220 designated as (g1). In normal operation, when the magnetic poles are energized with the proper magnetic polarity, the flux lines thus created will reach across this gap 220 as they are formed, and cause the rotor 210 to rotate to the position depicted in FIG. 2B, thereby reducing the reluctance in the magnetic circuit and reducing the air gap 230 to its smallest dimension designated as (g2). A torque impulse is also created during this motoring action, and the average mechanical work which is delivered on the rotor 210 will be found to be directly equal to the change in energy (Φ dI) within the air gap.

Referring now to FIG. 3, which is a double graph representing the energy relationship for the prior art motor illustrated in FIGS. 2A and 2B. The plot labeled 300 corresponding to air gap (g1) represents the relationship between the excitation flux and the excitation current at the point in time where the gap dimension is largest (e.g., air gap 220 as depicted in FIG. 2A). Note the larger value of the excitation current (I₁), and the relatively lower value of the associated flux (Φ₁). This is due to the fact that the large air gap has a high value of magnetic reluctance, and therefore requires substantially more current to produce the associated value of flux (Φ₁). This condition changes for the plot labeled 310 (corresponding to air gap g2), because the air gap has been greatly reduced, and much less current (I₂) is required to establish and hold the flux (Φ₂) within the magnetic circuit. Note that the current has reduced to value I₂, and the flux has actually increased to value Φ₂. This may sound like a positive result, but actually, it is not, because this large change in the flux (Φ) is also responsible for the production of an associated Back EMF.

For illustrative purposes, the following four calculations using equation 11 can be made representing the component energies associated with each air gap size (g1 and g2).

For a gap size g1: Φ₁dI=(13.5)(18−12)=81 Joules, and I₁dΦ=(18)(15−13.5)=27 Joules. For a gap size g2: Φ₂dI=(15)(18−12)=90 Joules, and I₂dΦ=(12)(15−13.5)=18 Joules.

Thus, each energy component has a different value, but much more interesting to note is that the total energies E1 and E2 which represent the energy for air gap sizes of g1 and g2, respectively, are equal (27+81)=(18+90)=108 Joules. This is consistent with the understanding that the motor shaft energy and motor input energy are equal in a motor of standard design, and co-exist within the motor structure. Hence, the term co-energy.

In further illustration of conventional DC motor operation, consider the following example of normal, Speed Voltage dependent operation. As depicted schematically in FIG. 4A, an exemplary standard DC motor with a power rating of 3.528 Horse Power has the following characteristics:

Full Load Speed=1800 RPM.

Continuous Shaft Torque=123.529 in-Lbs.

Terminal Voltage=124 Volts DC.

Full Load Current=26.326 amps.

Copper Losses=315.912 watts.

Other Losses=315.912 watts in the aggregate.

Back EMF Power Loss=2632.600 watts.

Shaft Power=3.528 H.P.

Total Input Power=3264.424 watts.

System Efficiency=80.645%.

Accordingly, if the proper voltage is applied to the motor terminals, and the mechanical load does not vary, the above properties should prevail indefinitely after thermal equilibrium has been reached. However, this same example DC motor will have drastically different properties upon first being started. This is illustrated by the diagram in the second diagram in FIG. 4B, showing the start-up, or inrush operation.

At the instant illustrated, the DC motor has not yet begun to rotate, and there is no Back EMF, but the starting torque is relatively large at 637.986 in-lbs, which is 5.165 times the running torque. The Back EMF that develops as a function of the motor's increasing rotational speed reduces the start-up current of 135.965 amps down to the full load ampere (FLA) value of 26.326 amps. This “high start-up current,” behavior is standard and expected in conventional Speed Voltage dependent motors.

Bearing these facts in mind, it stands to reason that for two, otherwise-identical, electric motors, the one that employs a larger, or surplus, number of winding turns per pole would experience a comparatively higher inductance L, and correspondingly, a relatively higher total Back EMF, resulting from the sum of Vs and Vt. Accordingly, to avoid this occurrence, it is typical in the prior art of electric motor design that the winding turns per pole are generally kept to a minimum, for a given operational voltage, thus allowing the Speed Voltage component to drive the design criteria, and minimize the Transformer Voltage component.

However, this engineering trade-off, of keeping inductance L low by using fewer windings, diminishes the amount of stored energy in the motor's magnetic circuit, and causes motor performance to be tied to the characteristics imposed by the Speed Voltage component of the Back EMF, most notably, the requirement for a higher magnitude source voltage and reduced torque output. Other motor design drawbacks and Back EMF issues also exist in prior systems.

Turning now to motor controls, the concept of a motor controller has evolved from such developments as electronic commutation for brush-less DC motors, automatic load-voltage regulators for single phase AC motors, soft-start circuits, current limiting circuits, variable frequency drives, and electronic packages for providing predetermined acceleration profiles for DC motors. Over time, all of these features have slowly merged into one, micro-processor controlled device which provides all of these various characteristics, and many more as well. However, the advent of the Back EMF reducing motor, such as the type described, for example, in co-pending applications disclosed herein, which are hereby incorporated by reference, now benefits from the development of a unique controller featuring control of bi-directional power flow.

Generally speaking, power in an electric motor circuit is expected to flow from source to load, and not to return. Previously, not much thought has been given to the re-use of such stored energy in a constructive way, or of returning it to the power supply from which it emerged.

This is particularly true in the case of existing DC motors. The present-day limitations in motor design do typically limit the accumulation and storage of any significant volume of magnetic energy during motor operation. In fact, in a typical motor energy dissipation is literally accelerated by, among other things, the degradation of potential supplied to the motor from an outside source. But, the type of controller disclosed herein is designed to return energy back to the source, and it operates in conjunction with a Back EMF reducing DC Motor as disclosed herein.

### SUMMARY

Accordingly, one advantage of some embodiments of the present invention is that it automatically controls and orchestrates the motor's internal functions, such as current limit, current switching, and direction of power flow.

Furthermore, an electric motor is disclosed, some embodiments having a single rotor segment, and other embodiments having a plurality of motor segments, each segment having a stator, having stator poles and stator windings and a rotor having a flux path element. For some embodiments, the flux path elements are attached to a rotor shaft at an oblique angle to the longitudinal axis of the shaft. The flux path elements have a shape that provides a uniform air gap between them and the stator poles when the shaft is rotated. The rotor shafts of said motor segments are mechanically coupled to each other.

In an embodiment, the flux path elements comprise a silicon steel lamination stack or a solid ferrite plate. In a further embodiment, the motor has a shaft angle sensor and a motor controller, and the motor controller receives a shaft angle from the sensor and supplies current pulses to the stator windings according to the shaft's angular position signal.

In a further embodiment, the stator poles are positioned in pole pairs with the rotor and rotor shaft between them and form isolated stator magnetic field circuits when the stator windings are supplied with electrical current, such that a magnetic field is established having a single magnetic polarity in each of the poles of said pole pairs, with each pole of the pole pairs having opposite magnetic polarity. In further embodiments more than two poles are installed in each stator section.

In a further embodiment, the rotor flux path elements have a shape defined by the volume contained between two parallel cuts taken through a right circular cylinder at an angle other than 90 degrees with respect to the axis of symmetry of said cylinder, each flux path element having front and back faces that are substantially elliptical, and having major and minor axes. In an embodiment, the flux element angle with respect to the axis of symmetry is substantially 45 degrees. In an embodiment, multiple rotors are attached to a common shaft, or to independent shafts coupled through a clutch or similar selectably engageable coupler, and the rotor flux path elements are arranged on said common shaft such that the major axes of the flux path elements are equally spaced on the shaft and wherein the stator poles are in the same position with respect to the common shaft for each motor segment. In another embodiment of this arrangement, the motor has two motor segments and two rotor flux path elements and the rotor flux path elements are arranged on the common shaft such that their major axes are spaced 90 degrees apart.

In a further embodiment, the motor has rotor counterweights to statically and dynamically balance the mass of the rotor flux elements.

In a further embodiment, the motor has starter windings adapted to start the motor in a desired rotational direction.

In a further embodiment, current generated in the windings from collapsing magnetic fields is captured and used.

One advantage of the presently disclosed system and method is that it addresses the drawbacks of existing systems.

Another advantage of the presently disclosed system is to provide a direct current motor which develops a significantly reduced Speed Voltage (Vₛ) component of the Back EMF.

Another advantage of the presently disclosed system is to provide a direct current motor which makes use of a plurality of salient poles within its stator structure that may possess characteristics different than typically employed by existing Speed Voltage dependent systems. For example, the stator poles should be arranged or constructed to be protected from flux movement in two directions in order to minimize eddy currents, and related iron losses. For example, fabricating all or part of the pole pieces from different metals, using grain orientation, using ferrite materials, using distributed air gap material, or laminations disposed at right angles with respect to one another, are some techniques that may be implemented to inhibit the production of eddy currents, and thereby lessen iron losses.

Another advantage of the presently disclosed system is to provide a direct current motor which employs a uniquely shaped rotor having a constant air gap with respect to the salient pole pieces. The constant air gap contributes to a smaller rate of change of inductance in the magnetic circuit, thereby reducing the speed voltage component Vs.

Another advantage of the presently disclosed system is to provide a direct current motor which employs a shaped rotor having no coils, windings, conductors or bars within its structure. This also contributes to a lower speed voltage component Vs of the Back EMF.

Another advantage of the presently disclosed system is to provide a direct current motor whose operation is governed by controller, such as an electronic controller, so designed as to orchestrate, synchronize, and control all the internal functions of the direct current motor.

Another advantage of the presently disclosed system is to provide a direct current motor with a surplus of salient pole windings which are configured to store re-usable magnetic energy within the stator power coil windings. The surplus windings arise from the additional windings possible with the presently-disclosed designs compared to the amount of windings on a similar capacity, traditionally designed DC motor.

These and other advantages are achieved in the presently disclosed system by providing a unique arrangement of stator and rotor geometries in conjunction with an electronic controller such that rotation is achieved by means of reluctance switching, synchronized by a position sensor, and acting in response to an electronic controller such that motor input power is properly managed and directed so as to produce a continuous rotation, while simultaneously recovering unused energy momentarily stored within the stator windings.

One embodiment of the presently disclosed system employs a rotor fabricated from a stack of steel disks, chemically insulated from one another to discourage and reduce eddy currents. The disks may be pressed upon an arbor which, in turn, is obliquely disposed with respect to the intended axis of rotation, and suitably machined so as to produce an assembly with a peripheral contour generally equivalent to that of a cylinder. The stator may be composed of a plurality of salient pole sets, each set comprising a pair of poles, and associated windings, arranged 180 degrees apart from one another upon the stator, and each pole set angularly displaced from one another by a desired number of mechanical degrees.

In some embodiments, each pole set may also be provided with a concave pole face, whose radius is slightly greater than the radius of the rotor. The rotor, therefore, defines an air gap of continuous dimension when rotated. The rotor is in magnetic series with each set of magnetic poles, thereby completing the magnetic circuit, and the rotor reacts to each set of energized poles by undergoing a mechanical displacement equal in degrees to the pole set's mechanical distribution around the periphery of the stator assembly. As the rotor rotates, the zone in which the flux is coupled to the active pole pieces may vary in position along the length of each pole face. However, the width of the air gap separating the pole face from said rotor will not vary.

This arrangement permits the magnetic potential within the air gap to remain substantially constant, thereby minimizing the change in induction which would normally give rise to the development of a large Speed Voltage (Vs). A greatly reduced Speed Voltage allows a reduced Back EMF in this embodiment of the disclosed direct current motor.

Another advantage of some embodiments is that, under certain conditions, such as the application of DC power to a reactive load, system energy derived from Transformer Voltage may be placed in storage periodically during operation, and its subsequent dissipation or its utilization may be implemented based upon circuit geometry, and/or the interaction with other circuit components.

Another advantage of embodiments of the disclosed embodiments is to provide proper coil switching functions in accordance with data delivered to the controller electronics from a shaft position sensor. The data may be utilized for instructing proper switching sequences for directing DC Power from both the positive and negative power supplies, to the proper magnetic windings so as to promote and sustain rotary motion.

Another advantage of some embodiments is to provide proper coil switching functions in accordance with data delivered to the controller electronics from the shaft-mounted angular position sensor so as to direct “Reactive” power from the magnetic windings to the positive and negative recapture reservoirs for storage and future use, either internally, within the motor system, or externally for powering an additional load.

Another advantage of some embodiments is to “boost” the voltage available in the positive and negative recapture reservoirs, to a value compatible with that of the potentials maintained in the Positive and Negative Power Supplies, and then monitor, and control power feedback as required by the system.

These and other advantages are achieved in the disclosed embodiments by integrating various control modules, each designed for producing a particular and discrete effect, into an overall control system which functions solely to synchronize and govern the various operational aspects of a Back EMF reducing motor such as those disclosed in the above-noted related applications.

Exemplary non-limiting embodiments are disclosed herein, however, it should be appreciated that other appropriate embodiments are encompassed by the present disclosure, the possible variations being too numerous to illustrate. It is understood that one of skill in the art would recognize that other potential circuit arrangements are capable of supporting proper controller operation as disclosed herein. Other aspects and advantages of the presently disclosed systems and methods will now be discussed with reference to the drawings.

### BRIEF DESCRIPTION OF THE DRAWINGS

FIG. 1 is a plot of flux versus current of air gap energy components in a typical prior art device.

FIGS. 2A and 2B are cross sectional views illustrating a change in air gap for a prior art device.

FIG. 3 is a plot of flux versus current for the linear energy relationship in the air gap for the prior art device shown in FIGS. 2A and 2B.

FIGS. 4A and 4B are equivalent schematic circuits for a prior art DC motor illustrating the steady-state and in-rush operation circuit values.

FIG. 5 is an overall view of one embodiment of the invention, showing stator sections in cut-away views revealing the disposition of bearings, common output shaft, rotor assemblies, counter weights, stator power windings and stator laminations.

FIG. 6 is a schematic diagram of an individual rotor/stator section, depicting the relationships between such components as rotor geometry, magnetic flux, air gaps, salient poles and power windings in accordance with some embodiments.

FIG. 7 is a schematic diagram showing maximum and minimum rotor cross-sections relative to air gaps, stator poles and magnetic circuits in accordance with some embodiments.

FIG. 8 is a block diagram of an exemplary motor system, depicting forward and rear motor sections, the motor load, the shaft position sensor, the electronic controller and the sump resistor in accordance with some embodiments.

FIG. 9 is a diagram of a single-rotor with a constant air-gap in accordance with some embodiments.

FIG. 10 is a diagram of a parallel output cluster of motor sections such as the one shown in FIG. 9 in accordance with some embodiments.

FIG. 11 is a motor coil energizing scheme for the motors of FIG. 10 in accordance with some embodiments.

FIG. 12 is a schematic of coil interconnections for eight motor sections mechanically connected in parallel in accordance with some embodiments.

FIG. 13A is a diagram of a motor cluster having brushes and commutator for timing in accordance with some embodiments.

FIG. 13B is a diagram of a motor cluster having an optical encoder for timing in accordance with some embodiments.

FIG. 14 is a block diagram illustrating the basic components of the disclosed motor system in which recovered energy from the motor's magnetic field is stored and reconditioned for use in powering appliances external to the motor in accordance with some embodiments of the invention.

FIG. 15 is a block diagram illustrating the basic components of the disclosed motor system in which recovered energy from the motor's magnetic field is stored, reconditioned, and then fed back to the capacitors in the appropriate primary power supply, where it is reused by the motor in accordance with some embodiments of the invention.

FIG. 16 is a schematic flow diagram disclosing one method utilized to supply direct current power to the motor windings, recapture the available energy, and then transform said energy into electrical power which can be delivered to external devices, either unaltered, as direct current, or through an inverter, so as to supply alternating current in accordance with some embodiments of the invention.

FIG. 17 is a schematic flow diagram disclosing one method utilized to supply direct current power to the motor windings, recapture the available energy, and then transform said energy into electrical power which can be delivered, through a feedback mechanism, to the capacitors in the appropriate primary power supply so as to reduce the amount of power required from external sources to propel the motor in accordance with some embodiments of the invention.

FIG. 18 is a functional schematic controller circuit diagram in accordance with some embodiments of the invention.

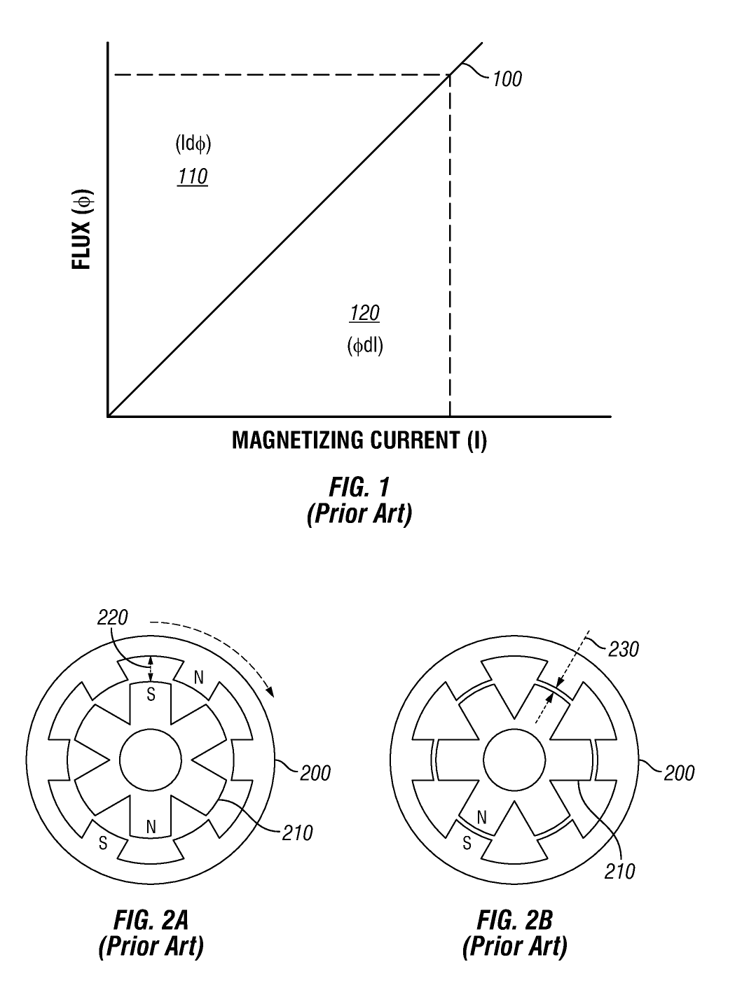

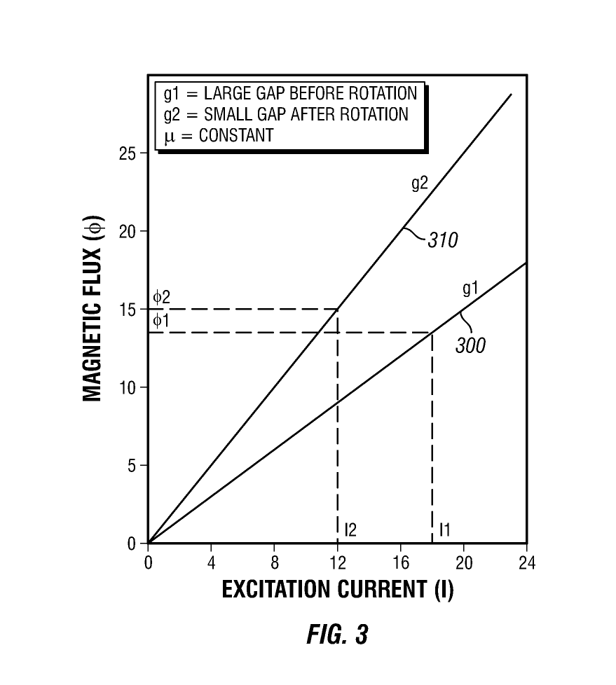

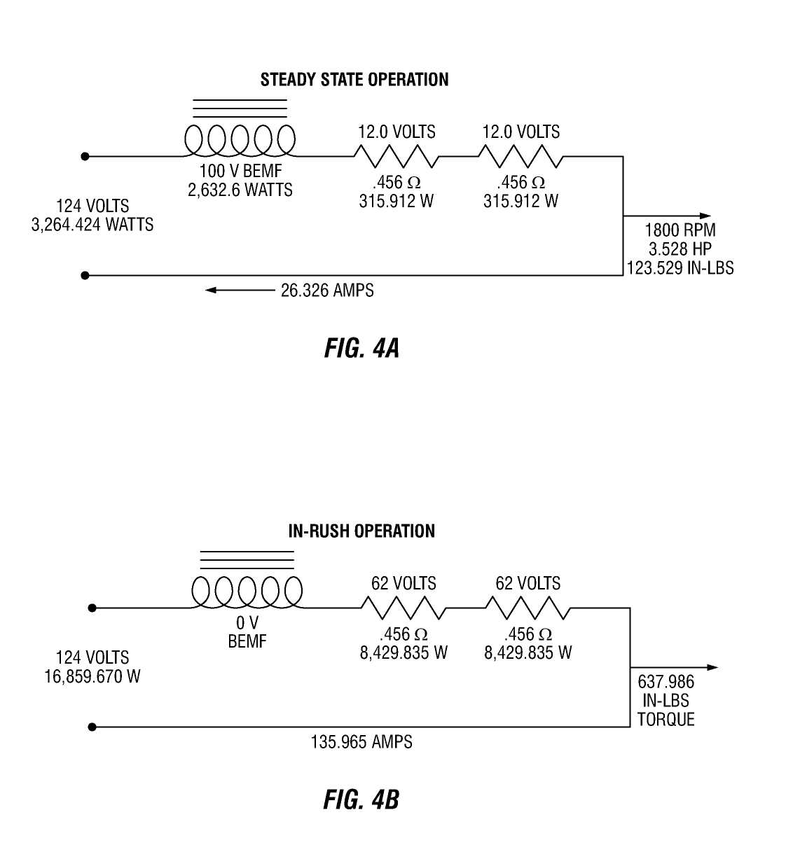

### DETAILED DESCRIPTION

In the following detailed description, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that various changes may be made without departing from the spirit and scope of the present invention. The following detailed description is, therefore, not to be taken in a limiting sense.

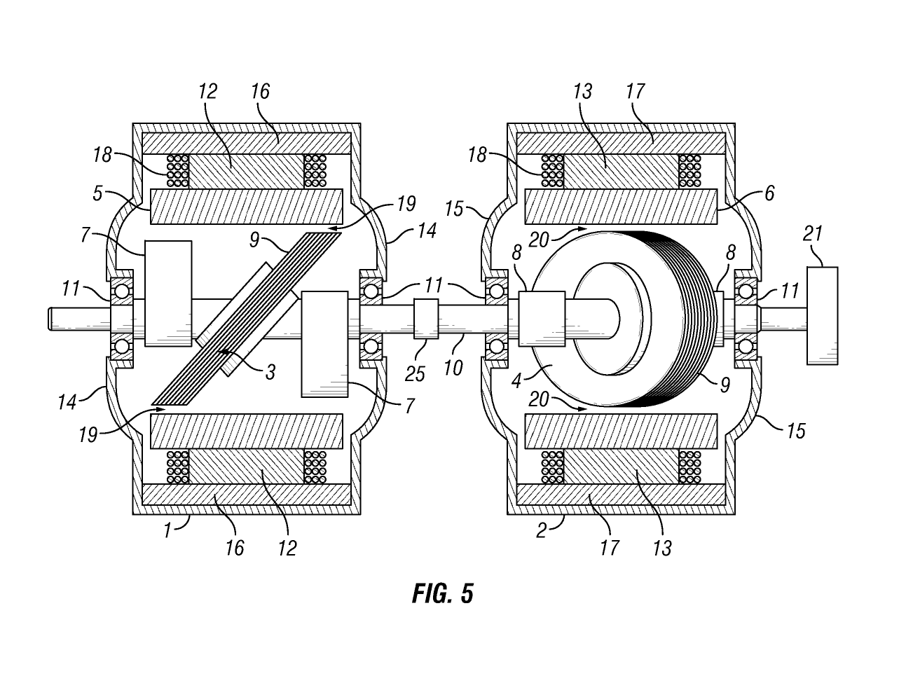

FIGS. 5-8 illustrate one embodiment of the motor disclosed herein. Reviewing FIG. 5, it will be seen that the motor consists of a double stator housing (1, 2) physically separated, but functionally joined together by means of a continuous shaft (10), upon which are mounted two armatures (3, 4), one within each stator assembly. The shaft is carried by bearing sets (11), located within end-bells (14, 15).

Rotor assemblies (3, 4) each consist of a stack of silicon steel laminations (9), a molded ferrite core, or any other high permeability magnetic material designed to suppress eddy currents, and machined so as to produce a section of a right circular cylinder canted at an angle of 45 degrees with respect to the motor shaft (10). When viewed face on, the rotor structure appears to be elliptical in shape. However, the side view depicts a rhomboid tilted at 45 degrees. This angle may not be the most optimal angle, and it should be realized that other angles may be employed without departure from the spirit of the invention.

The common shaft (10) may also carry counter weights (7, 8), as depicted, which function to ensure a smooth rotary motion by suppressing mechanical vibrations produced by the uneven mass distribution of the elliptical armature 5 sections (3,4). In another embodiment, each motor segment may include a clutch (25), or some other selectably engageable coupler in order to couple independent shafts into a common shaft (10). Of course, as many motor segments from one on upwards can be coupled in this, or a similar, manner.

Each stator assembly contains an individual stack of stator laminations (16, 17) or a magnetic ferrite cylinder, from which extend two or more salient pole projections (12, 13), each of which is wound with a power coil (18). The face of each pole projection (5, 6) is extended to the right and the left of center to ensure continuous air gaps of constant dimension (19, 20), which are aligned parallel to the rotor's edge contour regardless of its angular disposition. Those familiar with the art will realize that it may be possible to install more than two pole projections per armature without departing from the spirit of this invention. Under these conditions, the motor will, of course, operate with a single rotor.

The pole projections in each stator section are parallel to each other, but the rotor sections are displaced upon the shaft by a predetermined mechanical angle: 90 degrees for two pole sets 120 degrees for three pole sets, etc.

The motor shaft extends several inches beyond the end bell housings (14, 15) on each side of the motor. One end of the shaft is utilized as a take off point for mechanical power, or load, while the other side of shaft carries a shaft position indicator (21), which is an angular transducer, and may consist of a simple rotary encoder, or a more complex device containing discrete optical sensors and slotted disks.

The stator power windings may be connected in series or in parallel as preferred. The windings receive their drive pulses from switching transistors, MOSFETs, or other solid state switching devices within the controller (22), which in turn receive their firing instructions directly, or indirectly, from the shaft position sensor (21).

Power resistor (23) is used as a sump to harmlessly dissipate any remaining energy associated with the collapsing magnetic fields within the stator as the motor rotates.

A Description of the Rotor Geometry

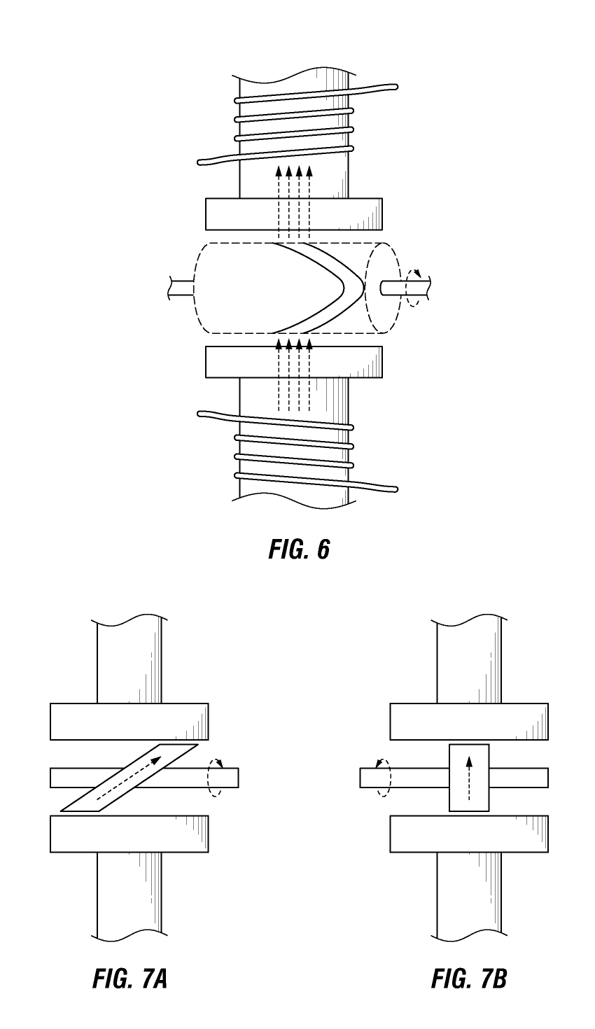

Drawing attention now, to FIG. 6, it will be noted, that a cylindrical outline is depicted between the poles of an electromagnet, through which the lines of flux are directed in a upward fashion. Notice also, the solid, elliptical lines shown. These demonstrate the shape of the lamination stack or ferrite core which comprises part of this invention. The shape is described by the result of making two parallel slices through a right circular cylinder at an angle of 45 degrees, and then removing all of the cylindrical body except the elliptical core, as demonstrated.

Magnetically, this elliptical rotor has some very interesting properties. FIG. 7 illustrates a schematic cross-sectional view of the flux path of the rotor in two mechanical positions, each 90 degrees apart. Note, in FIG. 7A, that the elliptical cross-section presents a longer path to the magnetic flux than does the cross-section illustrated in FIG. 7B. Note as well that these figures represent approximate flux paths and not actual cross sectional views of the rotor.

Accordingly, the elastic nature of the lines of flux will tend to exert a torque upon the rotor geometry, forcing the assembly to rotate 90 degrees, whereby the shortest path is available for the magnetic lines to complete their circuit as is evident in FIG. 7B.

This process does not require the presence of a “secondary” magnetic coil, the addition of which would tend to decrease a motor's overall inductance, by means of quadrature coupling, or armature reaction, during normal operation.

Detailed Description of the Motor's Operation

One embodiment of this invention employs two rotors, each fabricated from a stack of laminated disks, pressed upon arbors which are obliquely disposed with respect to the intended axis of rotation, and then integrally machined in order to provide both rotors with peripheral contours equivalent to that of a cylinder while retaining their overall elliptical shape. Each stator section is formed by a lamination stack having two, spaced-apart, salient pole projections terminating in concave pole faces whose radii are slightly larger than the radius of each rotor. Both rotors thereby define air gaps of constant dimension while rotating. Each rotor is in magnetic series with two air gaps and two pole pieces and a complete magnetic circuit which contains its own coils for the production of magnetic flux. Each magnetic rotor circuit is separate and distinct from each other magnetic rotor circuit, although they share a common output shaft. An angular position sensor or shaft encoder is positioned at one end of the output shaft, and sends electronic position signals to a DC power supply/controller, which in turn sends pulses to the motor stator sections as required.

The application of a current pulse to a given set of stator coils, causes the rapid rise of magnetic flux within the selected stator section and its associated rotor. The increased flux density then causes the rotation of the active rotor, as the flux lines “shrink” to ensure their manifestation in a circuit of minimum length. The output torque is produced by the laws of magnetic reluctance acting in conjunction with the innovative geometry of the rotor. No current carrying conductors are involved in the rotor.

As the first rotor reaches its position of minimum cross-sectional diameter, the shaft encoder then directs the electronic controller to send a power pulse to the second rotor, and the operation repeats itself. When this procedure is enacted every 90 degrees, the result is a smooth angular rotation, and the production of a continuous average torque. However, a secondary result of this arrangement is the production of an electrical output from each stator section as a result of the collapsing of its magnetic field at the end of each power cycle. This electrical energy may be harmlessly dissipated in a sump resistor, or it may be put to use, for example in powering other devices, including lamps or heaters or recovered to supply a portion of the energy used to drive the motor.

In an embodiment, an exemplary motor utilizes a rotor geometry consisting of a lamination stack or a molded ferrite shape, canted at a specific angle with respect to the output shaft, while retaining a circular cross section to the axis of rotation, and presenting an overall elliptical appearance in its own plane. This arrangement allows for a constant air gap to be maintained between the rotor's edge and the pole pieces thereby producing mechanical torque without the utilization of coils or conductors residing anywhere upon said rotor.

One embodiment of the motor employs a plurality of “elliptical” rotors mounted upon the same output shaft, but positioned such that each rotor section is advanced a certain number of mechanical degrees from the others such that torque production over 360 degrees of rotation is shared equally by the number of rotors utilized. The motor also has a plurality of pole sets and separate magnetic circuits, such that each elliptical rotor section is associated with its own external source of magnetic flux, regardless of the fact that they share a common output shaft. Accordingly, the salient stator pole projections will all reside in the same plane and be parallel to each other, while the rotor sections will be displaced upon the output shaft by predetermined mechanical angles; 90 degrees for two pole sets, 120 degrees for three pole sets, etc. Those skilled in the art will realize that this arrangement may be reversed without departing from the spirit of the invention. Likewise, those skilled in the art will also realize that it is possible to construct a single, standalone, motor utilizing a single rotor and stator section.

Referring now to FIGS. 5 and 7, which each depict the relationship of the rotors to the stators, it will be noted, that the left hand rotor is positioned between the salient poles of its stator such that its oblique length presents the longest possible path to the magnetic flux produced by the associated pole set. The right hand rotor on the same shaft, will simultaneously present its shortest cross sectional path to its associated pole projections.

Sensing this arrangement, the shaft position sensor (21) will cause the controller (22) to energize starting windings (not shown) which will rotate the motor shaft in the desired direction, while simultaneously sending a current pulse into the left hand pole set depicted in FIG. 5. Those skilled in the art will understand and appreciate how starter windings are implemented to start a motor in the desired rotational direction.

The appearance of lines of force within the first rotor segment will cause a twisting action upon that rotor's lamination stack, such that torque is produced upon the motor output shaft in the desired direction. At the same time, the right hand rotor is rotated, by the turning shaft, into a position of readiness with respect to the right hand magnetic pole set.

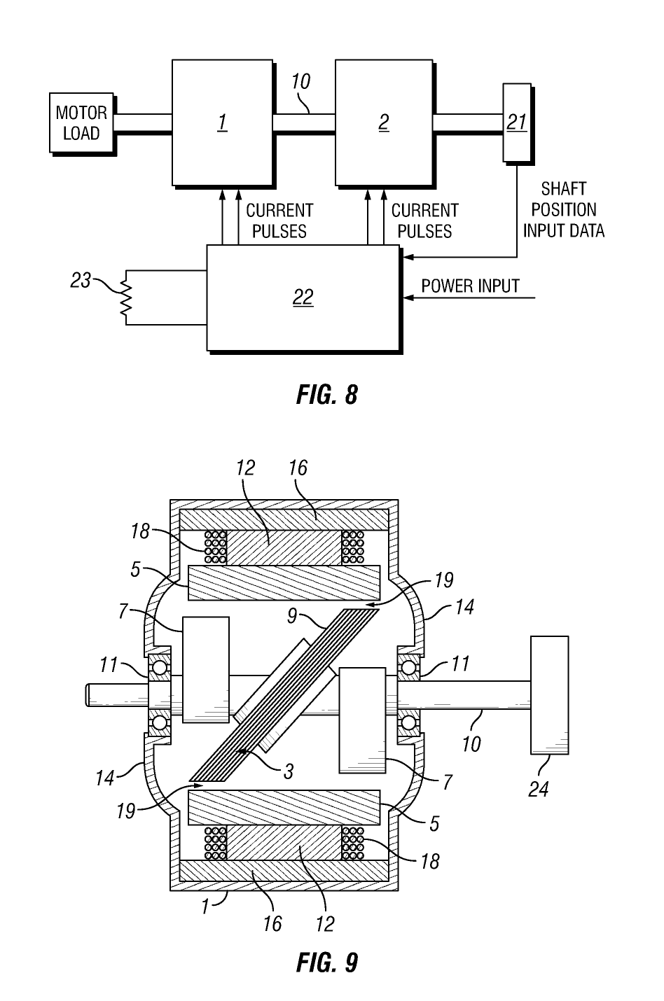

The shaft position sensor (21), illustrated in FIG. 8, then signals the controller (22), which directs a current pulse into the second stator pole set, advancing the output shaft by another 90 degrees. Utilizing this means, each motor half is alternately energized and a complete revolution of the shaft is achieved with every four electrical pulses. Thus a 900 RPM motor will require: 4 Pulses/Rev×900 Rev/Min.=3600 Pulses/Min supplied from the controller's power supply.

The average torque available on the motor output shaft will be a function of the cooperative effort developed by both rotors over each mechanical revolution. The output torque developed by this method is strictly a reluctance torque, generated as the lines of magnetic flux within each rotor section alternately shrink in an attempt to provide themselves with the shortest possible magnetic path between poles.

It is important to realize that this torque-producing mechanism does not involve any interaction of either stator's magnetic field with a current carrying conductor of any kind, neither in the form of a Speed Voltage interaction, nor in the form of a transformer coupling with a time-varying field. Instead, the torque appearing on the motor shaft is a direct function of the rotor's geometry interacting with forces produced at the boundaries between the rotor body and the stator poles, and by internal cam action particular to the rotor geometry in the presence of a contracting flux.

Magnetic energy stored in the stretched lines of flux between each pole set must be dissipated as each field structure collapses in response to instructions from the controller. This will ensure that an “empty” inductor will be available at the start of each 90 degree cycle. Accordingly, fly-back diodes are provided in association with each power winding. The diodes direct pulses generated by the collapsing fields into a sump or load resistor (23), where they may be harmlessly dissipated as excess heat. Alternatively, said energy may be used to power other electrical appliances external to the motor, or may be applied to a capacitive storage element and then utilized to send power back to the main power supply.

Efficiency and Scaling

Because of the rotor geometry, in conjunction with the fact that this type of reluctance motor carries no rotor windings, at least 50% of the I squared R losses, stray copper losses, and hysteresis losses experienced by traditional motor technology will be avoided in accordance with the spirit of invention.

Energy savings of this magnitude are possible primarily because of the constant air gap afforded by the rotor's geometry. However, it should be remembered, that any electromagnetic device so designed as to prevent a large change in the reluctance of its magnetic circuit, while ensuring a constant air gap during the course of any mechanically sponsored alteration in the mean circuit length, shall experience only minute variations in inductance. The operational benefits of such an arrangement will be that any force produced or work done by the electro-mechanical process, will have a minimal effect upon the magnetic excitation current.

Additionally, the use of high frequency switching technology to develop the required pulses of drive current, will ensure that conversion efficiency, or the transformation from electrical power to mechanical power, will be attainable in the high 90 percentile range.

Application of concepts herein disclosed may be arranged such that the rotor segments may be joined either in series, as depicted in FIG. 5, or in parallel, such that each rotor is equipped with a gear upon its output shaft, and several such assemblies are situated so as to drive a common gear and a main output shaft, or with single rotors in multi-pole embodiments. This adaptability is possible in series and parallel arrangements.

The scaling of these embodiments is relatively straightforward. Accordingly, no unusual difficulties are anticipated in producing small, medium or very large sized motors of this design.

In another embodiment, an electric motor cluster comprises several stator sections each possessing a minimum of two salient pole projections, wound with power windings, and each having a single armature rotor. Each individual rotor is angularly displaced one from the other, while mounted upon a common frame, and geared together such that each motor section contributes to the rotation of a common output shaft. Those skilled in the art will also recognize that it is possible to deploy a single, standalone motor with a single rotor and stator pair rather than as part of a cluster.

Such an arrangement not only allows for the combining of motor output powers and the removal of flutter from the final mechanical output, but simultaneously allows for a large increase in output torque by virtue of the necessary reduction gearing. The embodiment suggested within this particular disclosure lends itself perfectly to applications within the field of electric vehicle propulsion, particularly in those cases where the prime mover is to be located within the wheels of the vehicle. However, other applications are easily envisioned.

Each motor section shall consist of stator and armature elements as described in PCT application number PCT/US09/46246, filed on Jun. 4, 2009, and entitled “PULSED MULTI-ROTOR CONSTANT AIR GAP RELUCTANCE MOTOR.” The motor may consist of the following features:

A stator, consisting of a stack of laminations, or a molded ferrite core, so constructed as to provide at least one set of salient magnetic poles, spaced apart 180 mechanical degrees, and situated so as to allow an air gap to exist between the stator structure and the armature of the motor. Each salient magnetic pole projection may be wound with power windings, the function of which is to produce a magnetic field of considerable strength, and direct the same through the air gaps and into the body of the motor's armature.

An armature, also consisting of a stack of laminations, or a molded ferrite shape, so designed as to present each set of field poles with a cylindrical contour, perceived beyond each air gap, while retaining an elliptical profile with respect to the output shaft. The armature sections carry no electrical windings of any kind, and require no slip rings or, field coils or permanent magnets. However, armature segments may require shaft-mounted counter weights to offset their eccentricity, and maintain angular balance during rotation.

The power windings wound upon the salient pole projections, are energized by pulses of electric current produced by a DC power supply and provided through an electronic controller unit, or through a mechanical commutator, etc. The pulses are automatically applied to the salient pole nearest the longest flux path available through a particular rotor section, as determined by a shaft position sensor, or the geometry of a commutator.

The appearance of flux lines linking any stator pole set and any armature section immediately causes a rotation of the motor's output shaft by 90 mechanical degrees as the flux lines seek to establish the shortest possible path available for the completion of their magnetic circuit within a given motor.

This action is transmitted to the main output shaft via a large reduction gear, thereby increasing the available torque. In the motor cluster embodiment disclosed herein, several motor sections are positioned such that each may contribute to a common mechanical output. However, several such motor sections may be energized simultaneously, thereby increasing the output power in multiples.

Upon detecting motion, the shaft position sensor communicates the change in position of the output shaft to the electronic controller, and current flow is then terminated in each active stator section, and instantly initiated in the stator section windings next scheduled to be activated. By means of such switching action, which occurs at even intervals of mechanical degrees, a constant rotary motion is ensured.

FIGS. 9-13 illustrate one embodiment of the motor cluster disclosed herein. Reviewing FIG. 9, it may be seen, that each motor section consists of a metallic housing 1 containing a stator stack 16 and an armature assembly 3, which is mounted upon an output shaft 10, which is carried by two sets of bearings 11, located within end bells 14.

The rotor assembly 3 within each motor section, consists of a stack of silicon steel laminations 9, or a molded ferrite of appropriate shape, or any other high permeability magnetic material designed to suppress eddy currents, machined so as to produce a section of a right circular cylinder canted at an angle of 45 degrees with respect to the motor output shaft 10. When viewed face on, the rotor structure appears to be circular in shape. However, the side view depicts an ellipse tilted at 45 degrees. This angle may not be the most optimal angle, and it should be realized that other angles may be employed without departing from the spirit of the invention.

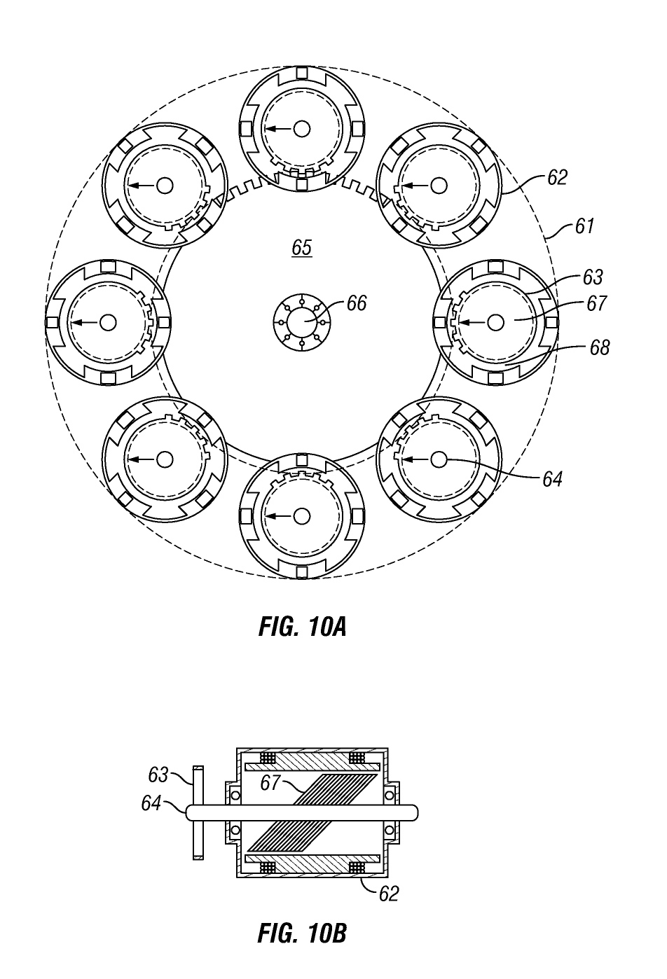

Each motor shaft 10 may also carry counter weights 7, as depicted, which function to ensure a smooth rotary motion by suppressing mechanical vibrations produced by the mass distribution of the eccentric armature design 3. Each motor shaft carries a high speed output pinion 24 which is designed to mesh with the main output gear as shown in FIGS. 9 and 10.

Each stator assembly contains an individual stack of stator laminations 16 or a magnetic ferrite cylinder, from which extend two or more salient pole projections 12, each of which is wound with a power coil 18. The face of each pole projection 5 is extended to the right and the left of center to ensure continuous air gaps 19 of constant dimension. The pole faces are aligned parallel to the rotor's edge contour regardless of its angular disposition. Those familiar with the art will realize that it may be possible to install more than two pole projections in association with each armature without departing from the spirit of this invention.

Referring now to FIG. 10, the concept of the parallel motor cluster will become apparent in greater detail. The embodiment depicted makes use of eight individual motor elements numbered clockwise, M1 through M8, starting at the 9:00 o'clock position. The motor elements are mounted at 45 degree intervals upon a circular frame 61. Each motor element consists of a laminated, four pole stator stack 62, an air gap 68, an elliptical rotor 67, an individual motor output shaft 64, and an output pinion 63. Further, it will be noted, that each output pinion is in mesh with a central output gear or “bull gear” 65 which drives the main output shaft 66.

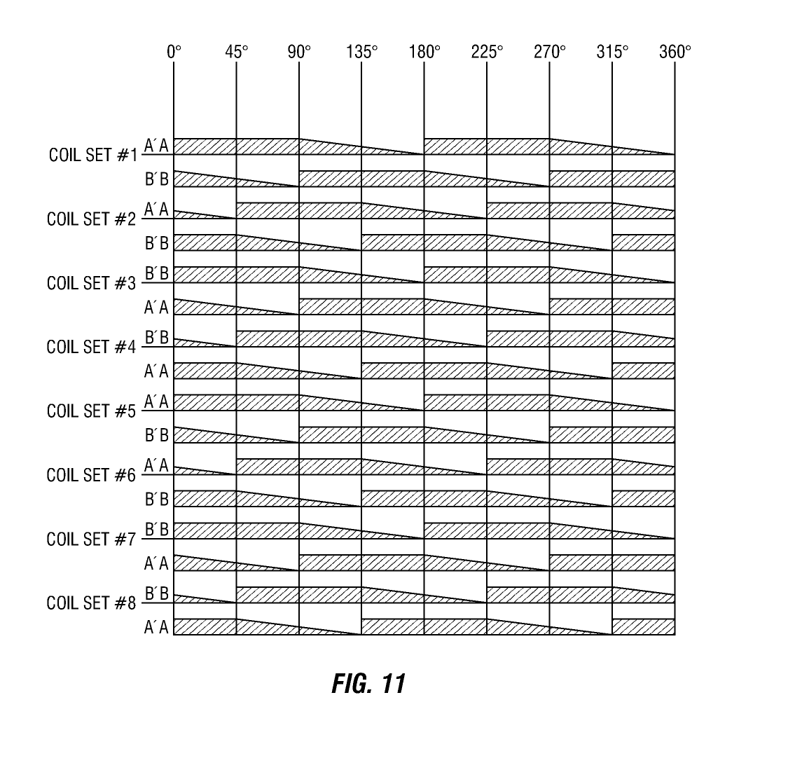

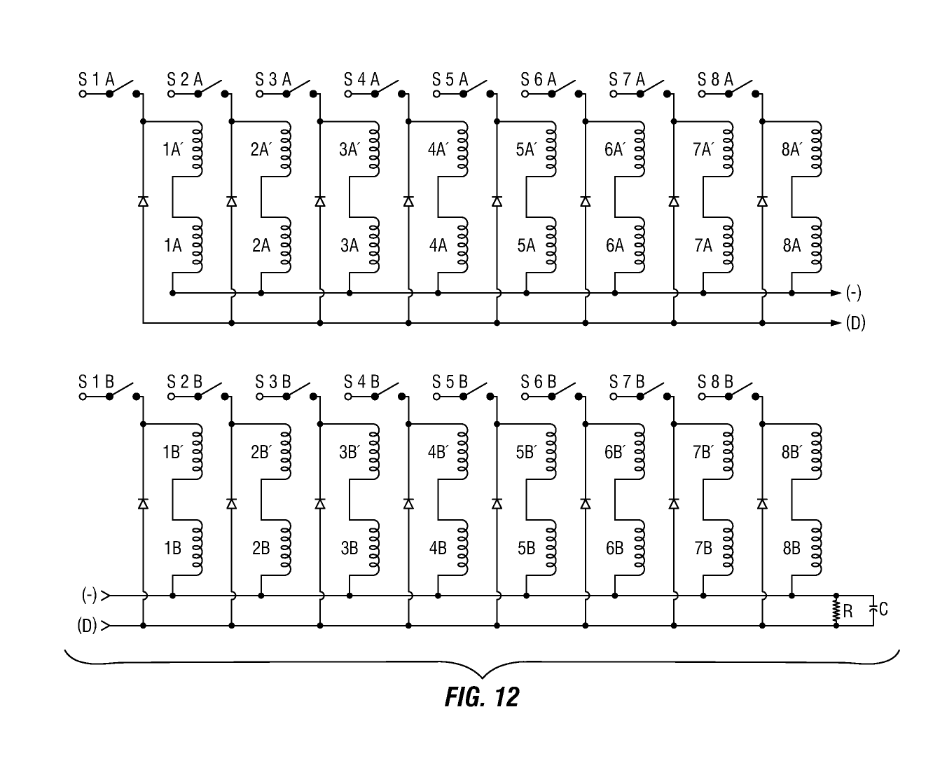

This arrangement allows for four motors to be energized at any one time, with power overlaps and torque-sharing occurring at 45 degree intervals. This feature serves to smooth out the total torque delivered to the output shaft, allowing for a more continuous delivery of power, as each contributing motor develops its output torque out of phase with respect to each of the others. Total motor action during operation may be appreciated by studying the coil energizing truth table depicted in FIG. 11, while the power coil interconnection schematic may be reviewed in FIG. 12. In FIG. 11, the horizontal portions of each chart depict energized coils and the sloped portions of the chart represent the magnetic reset of the energized coils. There are shown coil sets for eight motors as described in the above text with respect to FIG. 10.

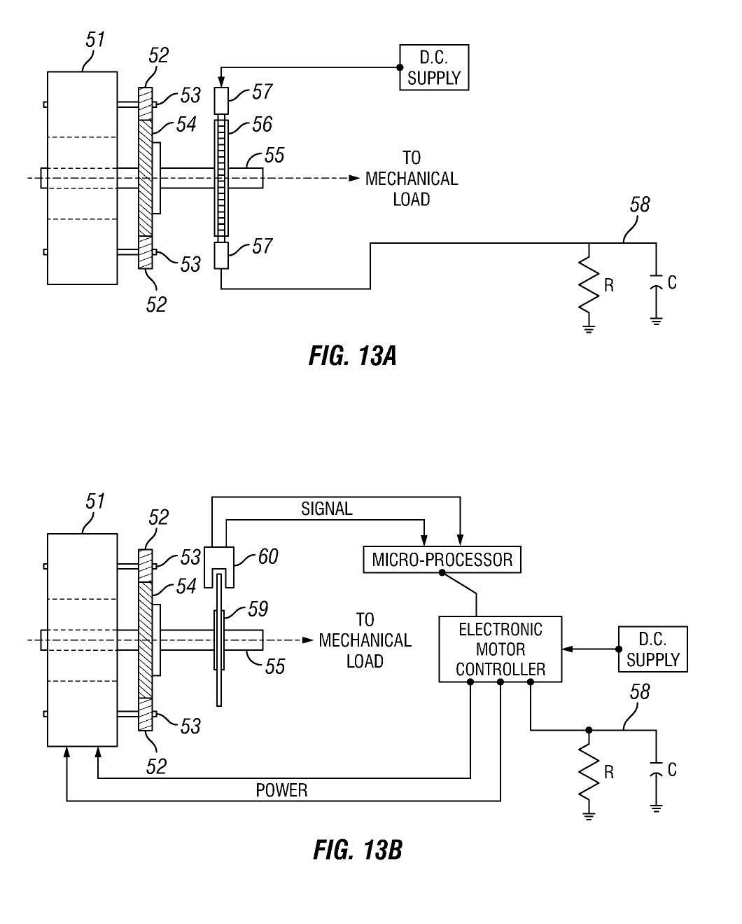

Referring now, to FIG. 12, it will be noted that switches S1A through S8A, and switches S1B through S8B, are used to control the power winding coil sets in each motor section. The coil sets are labeled A, A′ and B, B′ for each motor as shown in FIG. 10. These switches are schematically accurate, but may represent either solid state switching devices located within the electronic motor controller, or actual contact bars located upon a more traditional commutating device. These distinctions are more clearly explained in FIG. 13.

FIGS. 13A and 13B depict two variations of some embodiments of the present invention. FIG. 13A demonstrates the parallel motor cluster concept employing a traditional electro-mechanical commutating device 56, 57, while FIG. 13B demonstrates a more modern approach employing a shaft-mounted encoder 59, a micro-processor, and an electronic motor controller. It will be noted, that both systems require a source of DC power, as well as a capacitive power sump 58, into which excess “inductive energy” is directed. This “sump” may be equipped with a resistive load, which will consume said inductive energy, or the accumulated potential may be utilized to supply other worthwhile power requirements.

Returning now to FIGS. 13A and 13B, it will be noticed that each arrangement contains a motor cluster housing 51, a plurality of high speed motor pinions 52 mounted upon individual motor output shafts 53, and a central bull gear 54 mounted upon a main output shaft 55. However, FIG. 13A makes use of a mechanical commutation device 56 with standard carbon brush contactors 57, while the device shown in FIG. 13B employs a shaft encoder 59 and an encoder pick-up device 60.

Observing FIG. 13B, it will be noted that electronic signals obtained from the encoder assembly are transmitted to the micro-processor and the electronic motor controller, while power pulses are independently directed to individual motor windings via output conductors energized by the motor controller. Alternatively, the arrangement shown in FIG. 13A accomplishes these functions electro-mechanically, which may be advantageous in situations requiring the control of electric power greater than can be managed by present day solid state switching devices. Ultimately, however, both systems produce the results depicted in FIG. 11, and both systems ultimately direct inductive energies from collapsing magnetic fields into the capacitive sump indicated by network 58.

It should be understood that the embodiment discussed in this application and depicted in associated FIGS. 9-13, are for illustrative purposes only, and that those having skill in the electrical arts will understand that modifications and alterations can be made hereto, within the spirit of the present invention including but not limited to variations in the number of motors in the motor cluster.

As discussed previously, the parasitic effect of Back EMF, and motors designed to exploit Speed Voltage (Vs), imparts several drawbacks to existing systems. At least in part to avoid these and other drawbacks, the presently disclosed systems and methods are designed to operate on the production of Transformer Voltage (Vt). As disclosed herein, at least one advantage of such a design is that it allows the energy associated with the magnetic field to be re-captured and, in great measure, re-utilized.

To exploit the Transformer Voltage (Vt) instead of the Speed Voltage (Vs), the presently disclosed systems and methods implement the following two design principles arising out of the above discussion, and an understanding of the importance of equation 6 above. The first design principle implemented to exploit Transformer Voltage (Vt) is to introduce a parameter dl/dt corresponding to the change in magnetic circuit length over time. The second design principle is that to minimize the Speed Voltage (Vs) component the relation provided in equation 8 must be zero, or nearly zero. One way to accomplish a nearly zero Speed Voltage (Vs) is to minimize dL/dt by designing the air gap to be constant.

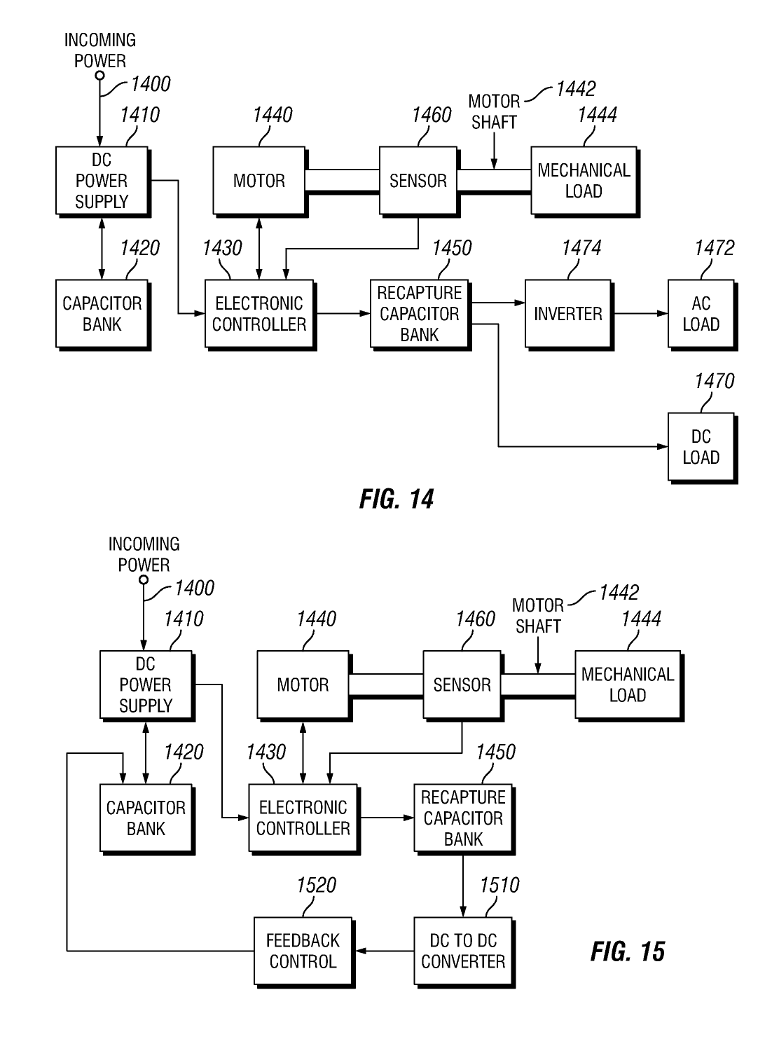

Referring now to FIG. 14, which is a schematic representation of a motor control system in accordance with some embodiments of the invention, incoming power 1400 may be appropriately conditioned (e.g., rectified, smoothed, or filtered) by a suitable device such as DC power supply 1410, and then passed on to a capacitor bank 1420 for further conditioning, and then passed on to the electronic controller 1430. In embodiments where battery power is the primary incoming power 1400, charge from the battery may first be passed through a DC-to-DC converter (not shown), and then stored in the capacitor bank 1420 at much higher potentials, and then delivered to the electronic controller 1430. Other input power 1400 conditioning mechanisms may also be implemented in accordance with a particular environment or application for the motor 1440.

As disclosed herein, electronic controller 1430 has at least two distinct functions. First, it supplies a series of pulses of proper magnitude and polarity to the motor 1440 so as to produce rotation of the motor shaft 1442 and drive a mechanical load 1444, and second, it directs energy recaptured from the motor 1440 windings to a second capacitor bank 1450 where the recaptured energy accumulates as the motor 1440 continues to rotate.

The operation of controller 1430 is influenced by input received from a sensor 1460, which, in some embodiments, is mounted upon the motor shaft 1442. Sensor 1460 functions to allow controller 1430 to monitor various motor 1440 operational characteristics. For example, in embodiments where the angular position of the motor shaft 1442 is important, sensor 1460 may comprise an angular position sensor that functions as a form of shaft encoder which reports specific angular positions of motor shaft 1442, the active quadrants, and other data to the controller 1430 for guiding its operation. Other types of sensors (e.g., rotational speed sensors, tachometers, commutator segment sensors, slip rings, brushes, Hall effect devices, optical sensors, magnetic sensors, or shaft encoders and readers, or the like) and other mounting locations may also be implemented.

In some embodiments, it may be desirable to store, or otherwise use, the energy recaptured from the magnetic fields with the motor 1440. As described herein, any number of suitable systems and methods for recapturing the energy may be implemented. For example, as shown in FIG. 14, some embodiments may implement a capacitor bank 1450 to store the recaptured energy.

In some reactive energy embodiments, energy recaptured from the magnetic fields within the motor 1440 will continue to accumulate within the recapture capacitor bank 1450 as long as the motor 1440 is in operation, however, this process may ultimately drive up the capacitor bank 1450 potential to the point of self-destruction if energy is not removed from the reservoir. To prevent such an occurrence, the recaptured energy may be directed to other storage devices (e.g., batteries), to power an electrical load external to the motor system, as indicated at 1470 and 1472, or otherwise dissipated (e.g., as part of a resistive heat source). As indicated, external load may be a DC load 1470 or an AC load 1472, depending upon the application and environment. If AC power is desired, then the recovered energy may be directed through an inverter 1474 or other conditioner to produce an AC output as indicated at 1472.

Referring now to FIG. 15, which is a schematic block diagram illustrating the basic components of the disclosed motor system in which recovered energy from the motor's magnetic field is stored, reconditioned, and then fed back to the capacitors 1420 in the appropriate primary power supply 1410, where it is reused by the motor 1440 in accordance with some embodiments of the invention. FIG. 15 is substantially similar to FIG. 14, and like elements are numbered alike. A difference in FIG. 15 is that the recaptured energy, residing in the recapture capacitor bank 1450, is not used to power any external appliances. Instead the recaptured energy is appropriately conditioned and then delivered back to assist in powering the motor 1440.

Conditioning of the recaptured energy may be accomplished in any suitable fashion. For example, and as depicted in FIG. 15, recaptured energy may be sent through a DC-to-DC converter 1510 which boosts the recaptured energy potential back up to the value contained in the primary power supply 1410. The recaptured energy may then be delivered back to the appropriate source capacitors 1420 under the guidance of a feedback control circuit 1520.

Feedback circuit 1520 may comprise any suitable circuit for moving the recaptured energy back to the primary power supply 1410. In some embodiments, the feedback circuit 1520 may deliver energy back to the primary supply 1400 in accordance with two command criteria: (1) the maximum allowable pre-set value of potential in the recapture bank 1450, and (2) the demand of the motor 1440 operational circuits, as interpreted by the electronic controller 1430.

By design, the initiation of power feedback from the recapture bank 1450 to the primary capacitor bank 1420 causes a drop in the power that is required from the incoming power source 1400, and this drop in wattage represents a savings which is exactly proportional to the volume of energy returned by the feedback system per unit time. If desired, it can be measured exactly. Thus, this presently disclosed system allows for a given volume of energy to be repeatedly re-used, with only system losses being supplemented by the external power source 1400.

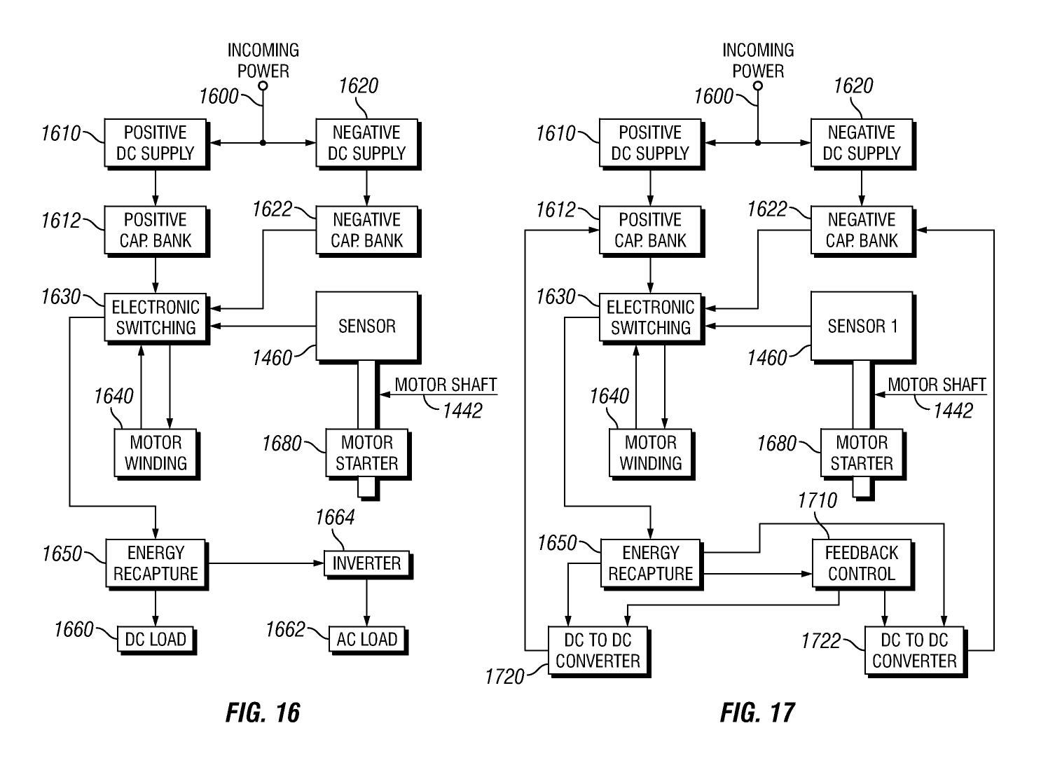

Referring now to FIG. 16, which is a schematic flow diagram disclosing an open power system in accordance with some embodiments of the invention. As shown for this embodiment, incoming power 1600 is directed to both a positive 1610 and a negative 1620 power supply. Embodiments of the disclosed invention may also provide for power supply conditioning. For example, a capacitor bank 1612 and 1622 may be provided with the respective power supplies 1610 and 1620. Having two power supplies may be desirable for embodiments for which currents of both polarities are desired to operate a Back EMF reducing motor in order to produce a torque of constant value and a steady output speed. In those embodiments, the proper blending and switching of positive and negative currents may be achieved by suitable switching elements 1630. Switching elements 1630 may comprise part of controller 1430 and may further comprise any suitable switching elements and associated circuitry for enabling the switching required to energize motor winding 1640. Furthermore, switching elements 1630 may receive input from other system components such as sensor 1460 in order to synchronize switching behavior. In addition, some embodiments may include a starter 1680 or other aid to initiate the rotation of the motor shaft 1442.

As shown schematically in FIG. 16, positive and negative impulses of DC power are delivered to the motor windings 1640 in proper phase and succession to produce, among other things, a smooth and continuous mechanical rotation of motor shaft 1442. In addition, each time a motor winding 1640 field is collapsed by the controller (e.g., by switching off the power to the winding), the energy stored in the associated winding 1640 develops an electrical pulse, which is then directed to suitable conditioning and storage. For example, as shown in FIG. 16, the pulses collected from the energy stored in the windings 1640 may be directed to the energy recapture capacitor bank 1650 by the controller 1430 where the energy may continue to accumulate as previously described.

As also previously described, the recaptured energy may be utilized to power appliances 1660 and 1662 external to the motor as depicted at the bottom of FIG. 16, thus producing an “open” power system, wherein the recaptured energy is used external to the instant motor system. As above, for applications where an AC appliance 1662 is to be powered, appropriate conditioning, such as by inverter 1664, may be implemented.

Turning now to FIG. 17, which is a schematic flow diagram disclosing a closed power system in accordance with some embodiments of the invention. FIG. 17 is substantially similar to FIG. 16, and like elements are numbered alike. A difference in FIG. 17 is that the recaptured energy, residing, for example, in the recapture bank 1650, is not used to power any external appliances. Instead the recaptured energy is appropriately conditioned and then delivered back to assist in powering the motor winding 1640.

As shown in FIG. 17, in some embodiments, the recaptured energy may be fed-back to the positive 1610 and negative 1620 primary power supplies by means of the feedback controller 1710 and appropriate conditioning circuitry. In some embodiments, and as shown in FIG. 17, appropriate conditioning circuitry may comprise one or more DC-to-DC converters 1720, 1722 as depicted. Embodiments, such as depicted in FIG. 17, where the recaptured power is fed-back ultimately to the motor windings 1640 are called a closed power system.

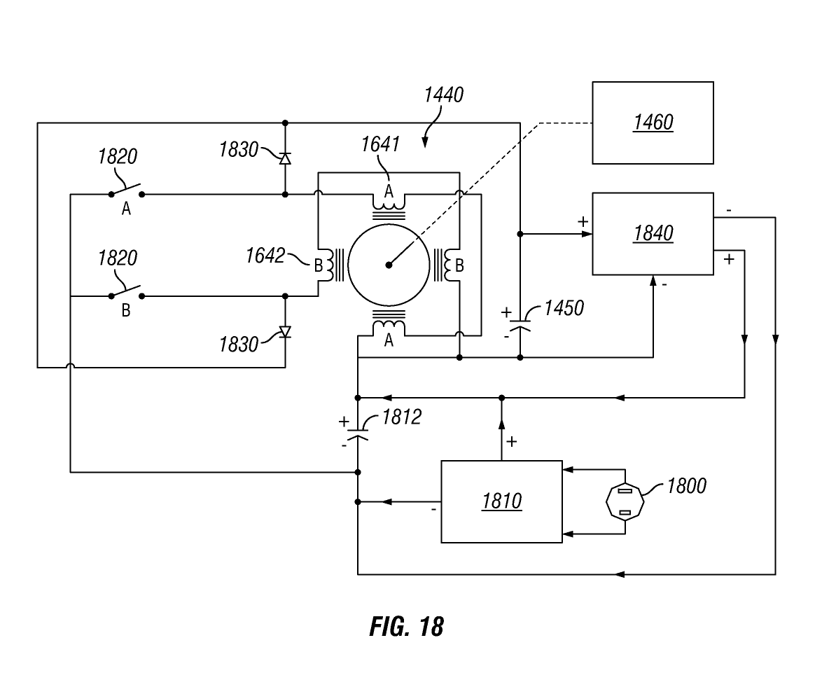

Turning now to FIG. 18 which is a functional schematic controller circuit diagram in accordance with some embodiments of the invention. As shown in FIG. 18, input power 1800 is delivered to the system and may be directed to a power supply 1810 (a DC power supply 1810 is depicted for this embodiment). The power supply 1810 supplies power to the motor 1440, and specifically to the pairs of windings 1641 (pair A) and 1642 (pair B). While two pairs (A and B) of windings separated by 90 degrees are shown, other configurations of winding pairs are also possible.

In some embodiments, each pair of windings (e.g., 1641, 1642) may be connected either in parallel or series and, typically, providing at least two connection points by which power is delivered to the windings (e.g., 1641, 1642). In some embodiments, one of the two connection points may be connected to the power supply 1810 as shown. Further, the second connection on each set of windings 1641, 1642 may be connected to the power supply 1810 through circuit interrupters 1820, such as switches A and B, which are controlled so as to turn on or off any given set of windings 1641, 1642. While circuit interrupters 1820 are shown as switches A and B, other suitable interrupters may be implemented, such as transistors, MOSFETS, digital circuitry, or the like.

As disclosed herein, circuit interrupters 1820 are controlled to open or close (i.e., on or off) in response to a sensed condition of the motor 1440. In some embodiments, sensor 1460 provides the appropriate sensed condition signal to effectuate control of circuit interrupters 1820. In some embodiments, sensor 1460 may comprise a rotational shaft position sensor that communicates the shaft position to trigger circuit interrupters 1820 to operate at the appropriate times with respect to the motor shaft 1442 position to achieve the desired shaft 1442 rotation. Other sensed conditions, such as motor RPM, elapsed time, or the like, may also be used (with appropriate sensors 1460) in order to trigger circuit interrupters 1820 and achieve the desired shaft 1442 rotation.

Opening of a circuit interrupter 1820 (i.e., turning off the winding 1641, 1642) causes the accumulated magnetic flux in the winding to collapse which, in turn, causes electric power to be generated in the winding as described herein. This winding generated power may be directed via an asymmetric conduction device 1830 into a recapture storage device 1450. Asymmetric conduction device 1830 may comprise any suitable circuit element to direct flow in substantially in a desired direction. For example, asymmetric conduction device 1830 may comprise a diode or the like.

In some embodiments, when the storage level in recapture storage device 1450 (e.g., a capacitor, battery, or the like) increases to a desired value, a power transfer circuit 1840 may transfer some or all the recaptured power from the recapture storage device 1450 back to the power supply 1810 to, among other things, keep the voltage of the recapture storage device 1450 relatively constant (i.e., the herein described “closed operation”). Alternatively, some or all of the recaptured power from the recapture storage device 1450 may be applied to external loads (e.g., 1472, 1470) (i.e., the herein described “open operation”).

While FIG. 18 has shown an embodiment of the controller 1430 as an analog circuit, it is equally possible to implement an equivalent digital circuit in a manner known to those of skill in the art. Likewise, for some embodiments of controller 1430, it may be desirable to include automatic over current detection circuits, which will compare actual motor current and feedback current to certain predetermined values, and initiate appropriate shutdown procedures, should these presets, or other safe operating parameters be exceeded.

While the invention has been described in detail and with reference to specific embodiments thereof, it will be apparent to one skilled in the art that various changes and modifications can be made therein without departing from the spirit and scope thereof. Accordingly, it is intended that the present invention covers the modifications and variations of this invention provided they come within the scope of the appended claims and their equivalents.

What is claimed is:

1. An electronic motor controller comprising:
a power delivery circuit that delivers power to an electric motor comprising at least one winding, wherein the power delivery circuit receives input power from a source and delivers power to the at least one electric motor winding;
a sensor input circuit that receives a signal from a sensor, wherein the signal is related to a sensed condition of the electric motor;
a circuit interrupter that controllably interrupts the power delivered from the source to the at least one electric motor winding based, at least in part, upon the signal received by the sensor input circuit;
a recapture storage device that captures energy generated by the interruption of power to the at least one electric motor winding; and
a power transfer circuit that controls the transfer of the energy stored in the recapture storage device.

2. The electronic motor controller of claim 1 further comprising:
an asymmetric conduction device that directs the flow of energy generated by the interruption of power to the at least one electric motor winding power in a preferred direction.

3. The electronic motor controller of claim 1 wherein the sensor is a shaft position sensor and wherein the sensor input circuit receives a signal from the sensor indicative of the position of the electric motor shaft.

4. The electronic motor controller of claim 1 wherein the recapture storage device is a capacitive storage device.

5. The electronic motor controller of claim 1 wherein the circuit interrupter is a switch.

6. The electronic motor controller of claim 5 wherein the switch is a mechanical switch.

7. The electronic motor controller of claim 5 wherein the switch is an electronic switch.

8. The electronic motor controller of claim 5 wherein the switch is a transistor device.

9. The electronic motor controller of claim 5 wherein the switch is a MOSFET device.

10. The electronic motor controller of claim 5 wherein the switch is an IBGT device.

11. The electronic motor controller of claim 1 wherein the controller comprises an embedded processor.

12. A method of operation for an electronic motor controller comprising:
directing power from an input power source to at least one winding of an electric motor to generate a magnetic flux;
receiving a signal from a sensor that indicates an operational condition of the electric motor;
controllably interrupting the power to the at least one winding based upon the received signal; and
recapturing the power generated by the subsequent collapse of the magnetic flux caused by the interruption of power to the at least one winding.

13. The method of claim 12 further comprising:
directing the recaptured power to the input power source for use in generating a magnetic flux.

14. The method of claim 12 further comprising:
directing the recaptured power to an external load.
